(19) United States
(12) Patent Application Publication
(10) Pub. No.: US 2016/0066525 A1
(43) Pub. Date: Mar. 10, 2016

(54) HYDROPONIC GARDEN SYSTEM

(71) Applicant: Group Rate Deals, LLC d/b/a Earth Prime Inc., New Orleans, LA (US)

(72) Inventors: Henry DUQUESNAY, New Orleans, LA (US); Karine DUQUESNAY, New Orleans, LA (US)

(21) Appl. No.: 14/846,547

(22) Filed: Sep. 4, 2015

Related U.S. Application Data
(60) Provisional application No. 62/046,443, filed on Sep. 5, 2014.

(51) Int. Cl. A01G 31/06

(52) U.S. Cl. CPC A01G 31/06

(57) ABSTRACT

Systems and methods for a vertical hydroponic garden described herein attempt to provide a solution to the geometry and spacing control between individual growing plants. The components can be combined for a complete standalone system or as a kit for assembly. An exemplary hydroponic garden system comprises a container configured to hold water; a support structure extending upward from the container; a plurality of housing components, each housing component configured to be supported by the support structure, each housing component having a plurality of apertures, wherein each aperture is configured to support a vessel configured for holding a plant; a pipe extending upward from the container through the housing components; and a pump configured to pump water from the container through the pipe to an upper most housing component, whereby water drips from the upper most housing component to the housing component below.

### CROSS-REFERENCE TO RELATED APPLICATIONS

This application claims priority to U.S. Provisional Patent Application Ser. No. 62/046,443, filed Sep. 5, 2014, which is hereby incorporated by reference in its entirety.

### TECHNICAL FIELD

The invention relates to hydroponics; in particular, to a vertical hydroponic garden system. This system provides for controlled spacing and environment for growing plants.

### BACKGROUND

Hydroponics is a subset of hydroculture and is a method of growing plants using mineral nutrient solutions, in water, without soil. A hydroponic garden may include a tray for growing plants, a water reservoir, and a pump for circulating the water from the water reservoir. For preservation of space, some attempts have been made at hydroponic garden towers, whereby a single column has a plurality of cups for growing plants. Other conventional vertical garden towers are not capable of recirculating the water, thus making the system inefficient. Other conventional vertical hydroponic garden towers are not rigid enough to stand up to foul weather and to support large plants. It is desirable to have a hydroponic garden system that allows for efficient production of the plants, can be configurable to different sizes and heights, is structurally strong to hold up to foul weather and support larger plants, and recirculates water amongst the components of the system.

### SUMMARY

Systems and methods for a vertical hydroponic garden described herein attempt to provide a solution to the structural rigidity for holding up to foul weather and support larger plants, while also addressing the geometry and spacing control between individual growing plants. The components can be combined for a complete standalone system or as a kit for assembly. The hydroponic garden system is configured as a vertical structure whereby nutrient-enriched water can be pumped to the top of the system, and the water can drip down through each stacked housing component to water the roots of the plants in each housing component.

Each housing component may be constructed from a single component. Alternatively, each housing component may comprise more than one component. For example, the housing component may include a housing component base and a housing component cover, which can be secured to the housing component base. The combination of the housing component base and the housing component cover may be referred to herein as a “housing component.” In the exemplary embodiment, the housing component cover can include the apertures for holding the plants.

In one embodiment, a hydroponic garden system comprises a container configured to hold water; a support structure extending upward from the container; a plurality of housing components, each housing component configured to be supported by the support structure and positioned vertically along the support structure, each housing component having a plurality of apertures, wherein each aperture is configured to support a vessel configured for holding a plant; a pipe extending upward from the container through the housing components; and a pump configured to pump water from the container through the pipe to an upper most housing component, whereby water drips from the upper most housing component to the housing component and to the housing component below.

In another embodiment, a kit for a hydroponic garden comprises a container configured to hold water; a support structure configured to extending upward from the container; a plurality of housing components, each housing component configured to be supported by the support structure, each housing component having a plurality of apertures, wherein each aperture is configured to support a vessel configured for holding a plant; a pipe configured to be installed to extending upward from the container through the housing components; and a pump configured to pump water from the container through the pipe.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawing, which are incorporated herein and form part of the specification, illustrate some, but not the only or exclusive, example embodiments and/or features. it is intended that the embodiments and figures disclosed herein are to considered illustrative rather than limiting.

FIG. 1 is a perspective view of a hydroponic garden system, according to an exemplary embodiment.

FIG. 2A is an exploded perspective view of a container and integrated support structure, according to an exemplary embodiment.

FIG. 2B is an exploded perspective view of a container and integrated support according to an alternative exemplary embodiment.

FIG. 3A is a perspective view of a support structure, according to an exemplary embodiment.

FIG. 3B is a perspective view of a support structure, according to an alternative exemplary embodiment.

FIGS. 4A and B are a perspective view of a housing component base and a housing component cover, according to an exemplary embodiment.

FIG. 5A is a perspective view of a housing component base, a housing component cover, and support structure, according to an exemplary embodiment.

FIG. 5B is a perspective view of a housing component base, a housing component cover, hooks, and a fence line, according to an exemplary embodiment.

FIG. 6 is a perspective view of a housing component base, a support structure, and a locking mechanism, according to an exemplary embodiment.

FIG. 7 is a perspective view of a housing component base, housing component cover, a support structure, and a locking mechanism, according to an exemplary embodiment.

FIG. 8 is a perspective view of a container, integrated structure, and a housing component base, according to an exemplary embodiment.

FIG. 9 is an perspective view a housing component base, housing component cover, PVC pipe, rods, and container cover, according to an exemplary embodiment.

FIG. 10A is a perspective view of an alternative housing component, according to an exemplary embodiment.

FIG. 10B is a side view of the alternative housing component in a stacked configuration, according to an exemplary embodiment.

FIG. 11 is a cross-sectional view of a housing component and cup, according to an exemplary embodiment.

FIG. 12 is an exploded view of a hydroponic garden system with an alternative housing component, according to an exemplary embodiment.

FIG. 13 is a perspective view of a container, cover, and all kit parts, according to an exemplary embodiment.

FIG. 14 is various cup configurations, according to exemplary embodiments.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

The embodiments described herein recite systems and methods for a vertical hydroponic garden that attempts to provide a solution to the geometry and spacing control between individual growing plants. The components can be combined for a complete standalone system or as a kit for assembly. As used herein, the term “hydroponic” refers to various soilless growth systems including hydroponic, aeroponic, and aquaculture or aquaponic growth systems.

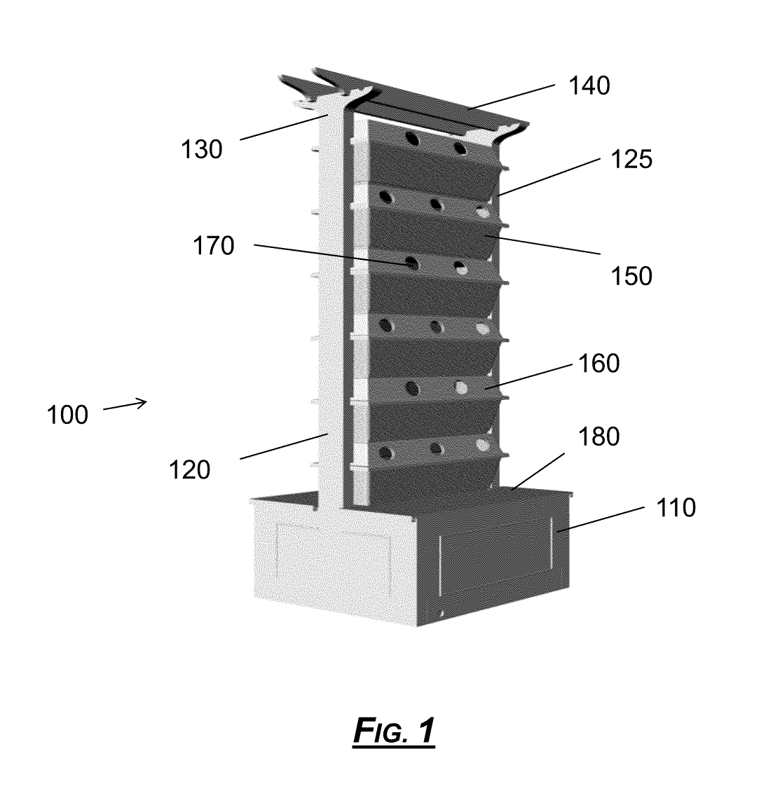

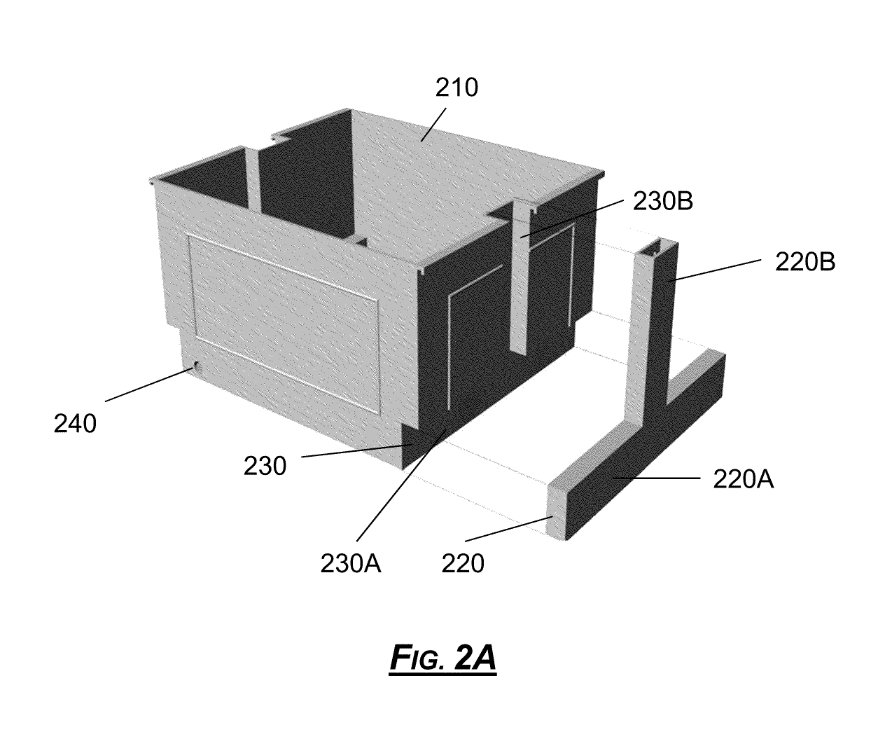

Referring to FIG. 1, a hydroponic garden system 100 is shown. The system 100 has a container 110 at the base. The container 110, constructed from a rigid material, has a substantially rectangular bottom surface and four sides extending from the substantially rectangular bottom surface. The container 110 is configured to hold water, which can be useful in adding weight to the base of the system 100.

A support structure 120, 125 extends upwards from the container 110. The support structure 120, 125 is shown as a first component 120 and a second component 125, but it is intended that the support structure 120, 125 can be configured as a single component where the first component 120 is adjoined to the second component 125. In an alternative embodiment, the support structure 120, 125 can be constructed from multiple components.

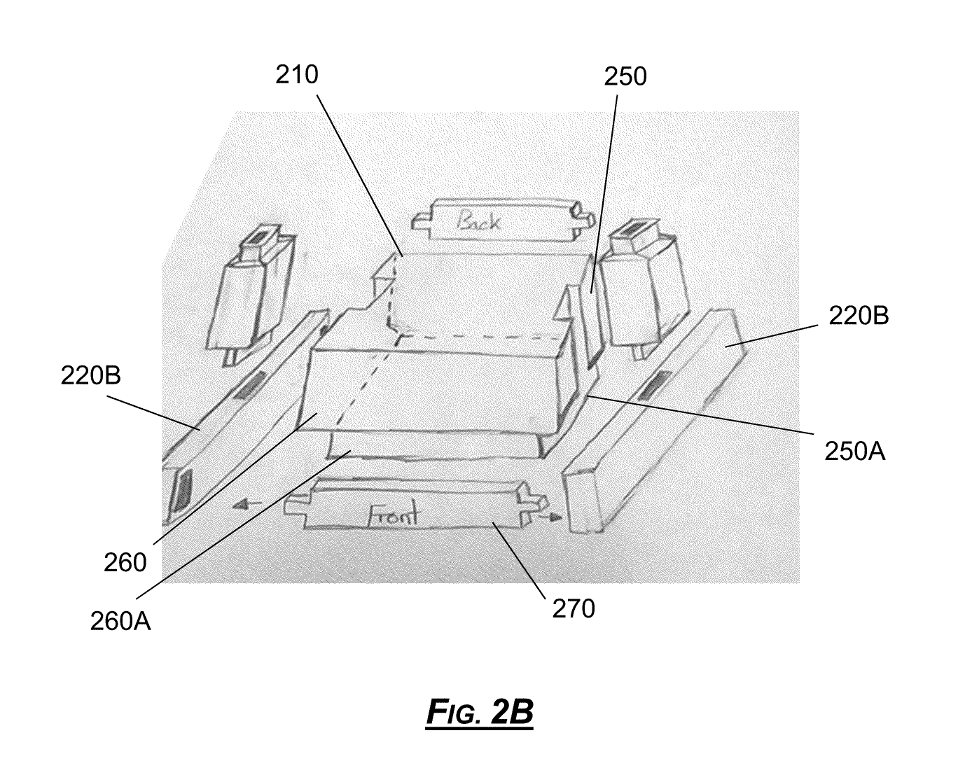

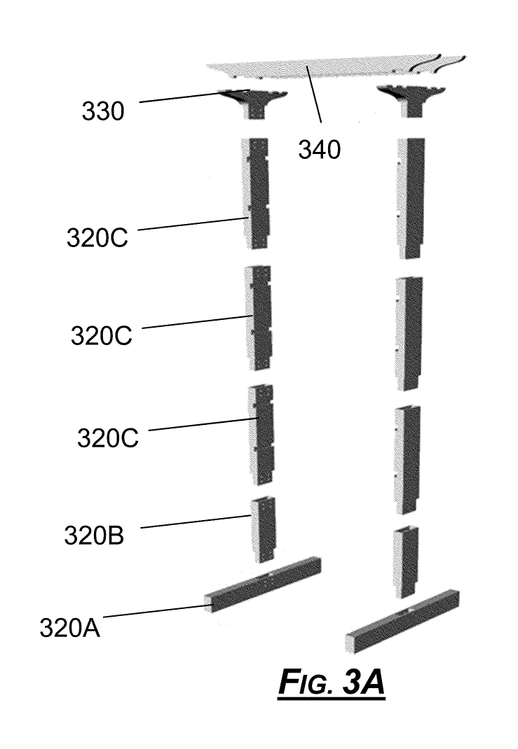

The container 110 can be configured to interface with and support the support structure 120, 125. As shown in the exemplary embodiment of FIG. 2A, container 210 has a recess 230 on at least two sides of the container 210. In this embodiment, container 210 has the recess 230 on opposing sides to engage with a support structure 220. Although FIG. 2 shows recess 230 is on one side of the container 210, it is intended that the container can be configured such that any one or any combination of sides can have the recess 230. A base of the support structure 220 is configured with a horizontal component 220A and a vertical component 220B that is secured substantially in the center of the horizontal component 220A. The support structure 220 can extend beyond the height of the container 210, but is only shown here as extending to the same height as the container 210. The recess 230 on the container 210 is configured to resemble the shape of the support structure 220. Accordingly, the recess has a horizontal component 230A configured to receive the horizontal component 220A and a vertical component 230B configured to receive the vertical component 220B. When the container 210 is substantially filled with water, the container 210 weighs on and secures the support structure 220. As a result, the support structure is more stable at its base, thereby allowing a more rigid structure.

The container 210 has a drain 240 with a plug (not shown) on the container 210. The drain 240 can be configured to receive a plug or tubing connected to a pump on the inside of the container and a hose simultaneously on the outside of the container 210.

As shown in FIG. 2B, a container 210 has a recess on each side of the container 210. In this perspective view, only two sides are shown, and the opposing sides are similarly configured. Side 250 has a recess 250A, which is configured similarly to the recess shown in FIG. 2A. Side 260 has a recess 260A, which is configured to receive a horizontal component 270 that connects each horizontal component 220B. This configuration can add further stability to the structure by connecting both sides of the support structure and weighing on the additional components when the container 210 is substantially filled with water.

A cross beam 140 can be substantially the length of the container 110 and can be configured to couple an upper portion of the support structure 120, 125. The support structure can include an adapter 130 that connects to the support structure 120, 125 as well as the cross beam 140.

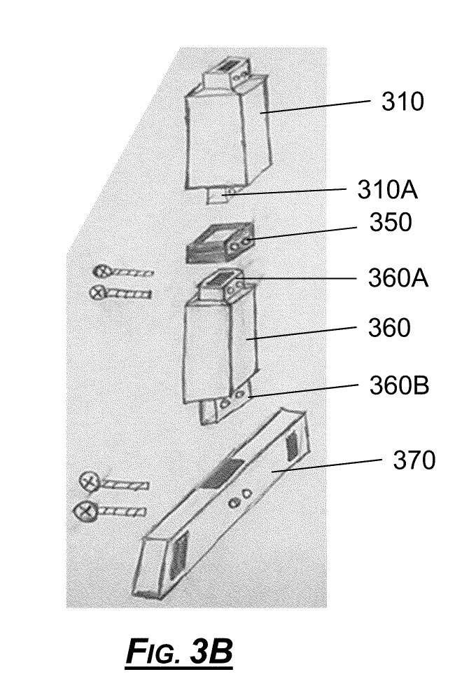

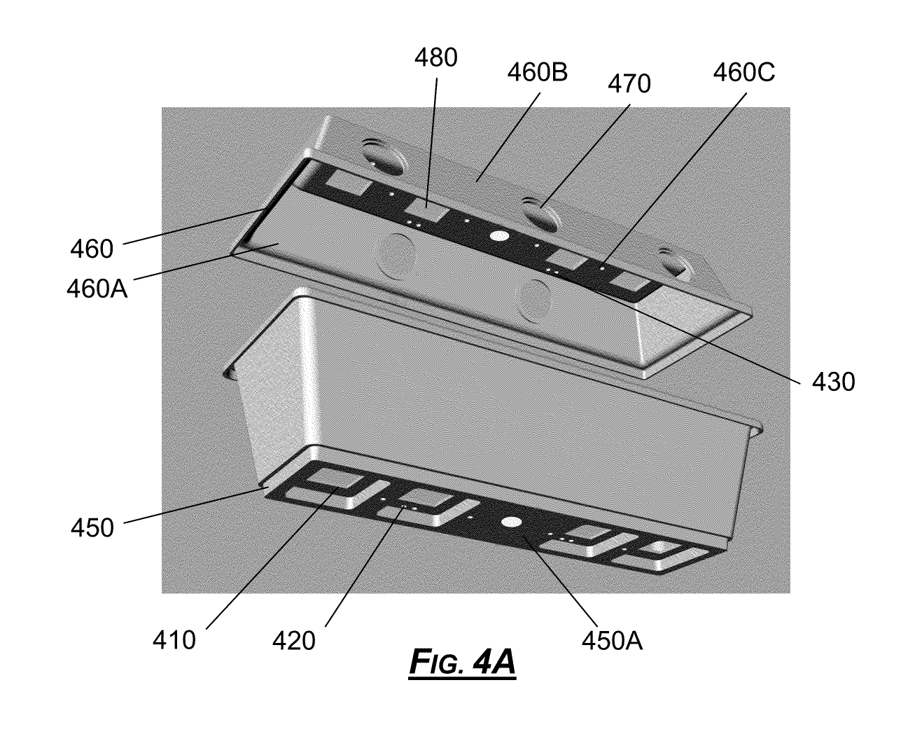

As shown in FIG. 3A, a support structure has a horizontal support structure component 320A and a vertical support structure component 320B extending therefrom. The horizontal support structure component 320A and the vertical support structure component 320B can be constructed as a single component or as separate components that can be secured to each other using interlocking components, pins, brackets, clamps, screws, nuts and bolts, or other similar attachment mechanism. The support structure may be extended by further attaching support structure extension 320C. Three support structure extensions 320C are shown on each side, though any number of extensions may be used. The extensions 320C can be attached to each other or other components using interlocking components, pins, brackets, clamps, screws, nuts and bolts, or other similar attachment mechanism. At the top of the support structure, an adapter 330 attaches to the uppermost extension. The adapter 330 is configured to attached to a cross beam 340, which is also attached to the other side of the support structure.

The support structure can be made of plastic, wood, wood-composite, metal, or any other rigid material. In one configuration, components of the support structure can have holes at an end to allow the next beam to slide into it and then be bolted together. Where these components connect, a metal bracket can surround the joint to further secure the strength of the system. The metal bracket can optionally connect with latticework design to attach to the brackets. The support structure can include an upside-down L-shape or hook. The hook can be routed or formed into the sidewall of the support structure. Or the support structure can include a metal plate. The hook or the plate can be used to receive and secure the housing component by hooking underneath or through an edge or lip of the housing component.

As shown in FIG. 3B, the support structure can be constructed by assembling a first vertical component 310 with a first male extension 310A into a bracket 350 and a first male extension 360A of a second vertical component 360. The second vertical component 360 has a second male extension 360B that is received by a horizontal component 370.

A stackable hydroponic housing component can be a specially-configured housing having sides, a bottom, and/or a top. In this exemplary embodiment, a housing component base 150 has a bottom surface with four side walls extending therefrom. The housing component base 150 can be covered by a housing component cover 160 that is configured to fit on top of the housing component base 150. Together, the housing component base 150 and the housing component cover 160 form a housing component, which may be constructed as a single component. The housing component base 150 and the housing component cover 160 can have angled sides that extend away from the bottom of the housing component base 150 and extend away from the top of the housing component cover 160. Such an angled configuration can allow for a more secure planting. The angled configuration can also allow for ease of packing, whereby each housing component base 150 or housing component cover 160 can be stacked inside another housing component base 150 and/or housing component cover 160.

The housing component cover 160 has a top surface with four sidewalls extending therefrom. The housing component cover 160 can include a plurality of apertures 170 in a side wall and a plurality of apertures in the top surface.

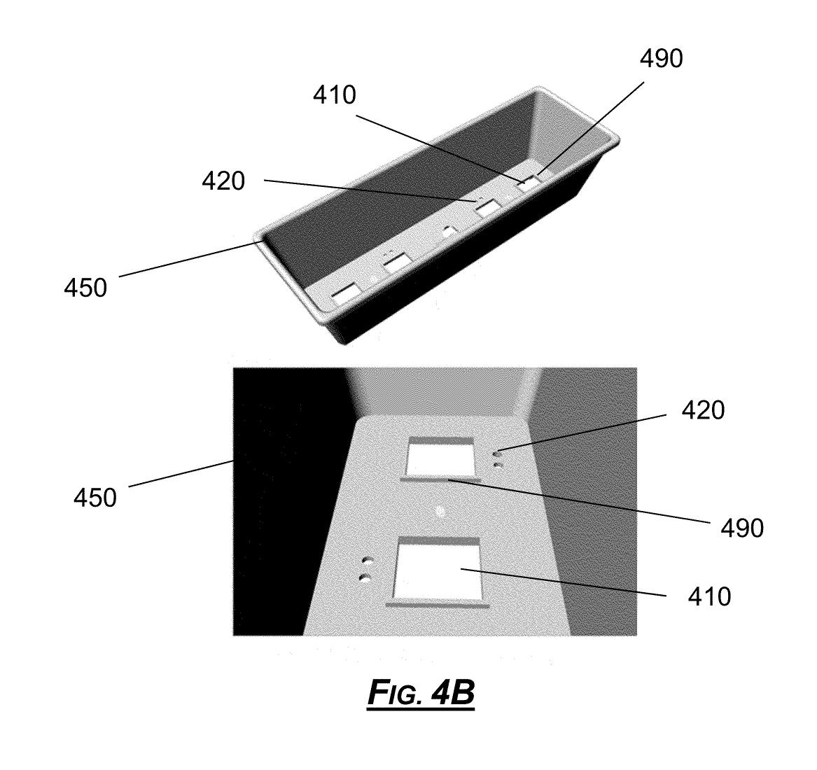

As shown in FIGS. 4A and 4B, a bottom surface 460A of housing component cover 460 has a plurality of square-shaped apertures 410. Although four square-shaped apertures are shown, any number and any shape of apertures can be used. The housing component cover 460 adjoins the housing component base 450 along the edge of the sides. The housing component cover 460 can have a flange that extends over an edge of the housing component base 450 to allow the housing component cover 460 to remain in a single position on top of the housing component base 450. The housing component cover 460 has a plurality of apertures 470 in two opposing sides 460A, 460B. In the exemplary embodiment, side 460A has two circular apertures 470 and side 460B has three circular apertures 470, but any number and any shape of apertures can be used. The housing component cover 460 has a plurality of square-shaped apertures 480 in a top surface 460C. Although four square-shaped apertures are shown, any number and any shape of apertures can be used.

The housing component base 450 has a plurality of circular-shaped smaller apertures 420. Similarly, the housing component cover 460 has a plurality of circular-shaped smaller apertures 430. Although numerous circular-shaped apertures are shown, any number and any shape of apertures can be used. These apertures 420, 430 may be positioned near the square shaped apertures 410, 480. The circular-shaped apertures 420 can allow water to drip from the housing component 450 to a housing component cover 460 below, where the circular-shaped apertures 430 will receive the water and allow it to drip on the plants housed within the housing component below. The perimeter of square-shaped apertures 410, 480 can include a lip or flange 490 that can assist in directing water to the circular-shaped apertures 420, 430.

The apertures 480 in the top surface 460C are configured to be aligned with the apertures 410 in the bottom surface 450A when the housing component 450 having a cover 460 is stacked on top of another housing component base 450 having a cover 460, thereby allowing roots of plants to extend therethrough and to allow water to pass from an upper housing component to a lower housing component when the housing components are stacked. Roots of plantings within the housing components can receive the water passed from an upper housing component. The smaller apertures 420, 430 (e.g., circular or rounded apertures) may be configured for water to drip from one housing component to another. The larger apertures 410, 480 (e.g., square apertures) may be configured to allow roots to extend and excess water to flow from the housing component.

The support structure 120, 125 is configured to support the housing component 150. As a longer support structure 120, 125 is used or as more support structure extensions are added, the support structure 120, 125 can support more housing components. In this exemplary embodiment, six housing components are shown. However, any number of housing components can be used. Also, in this exemplary embodiment, the housing component bases 150 each have the housing component cover 160 on top, and the housing component bases 150 are stacked vertically, but it is intended that the housing component bases 150 can have a different configuration as long as it is consistent with the scope of this disclosure. The housing component covers 160 can be installed so that the number of apertures on each side alternates for each housing component cover 160 in the stack (e.g., two apertures, then three apertures, then two apertures). The staggered apertures can provide for an optimal configuration for growing plantings in the housing components.

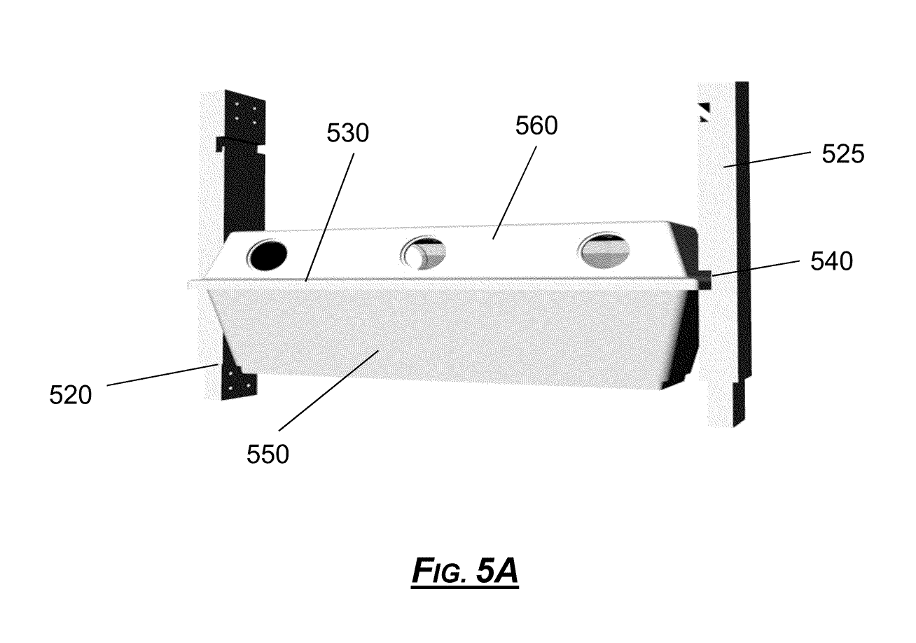

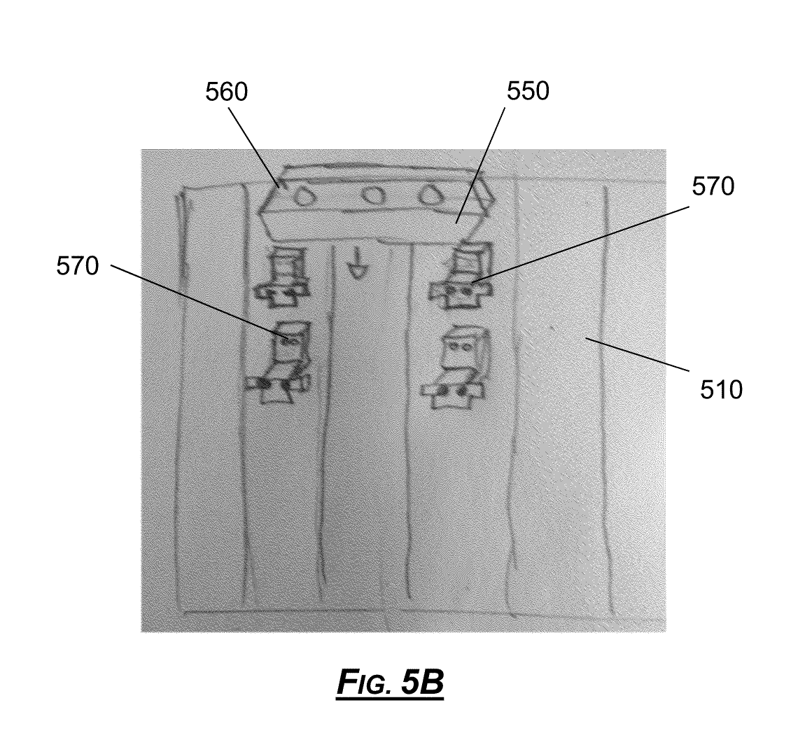

As shown in FIG. 5A, a housing component base 550 having a housing component cover 560 is secured in position and supported by support structure 520, 525. An edge 530 where the housing component base 550 and the housing component cover 560 are adjoined can be received by a recess 540 and panel in the support structure 520, 525.

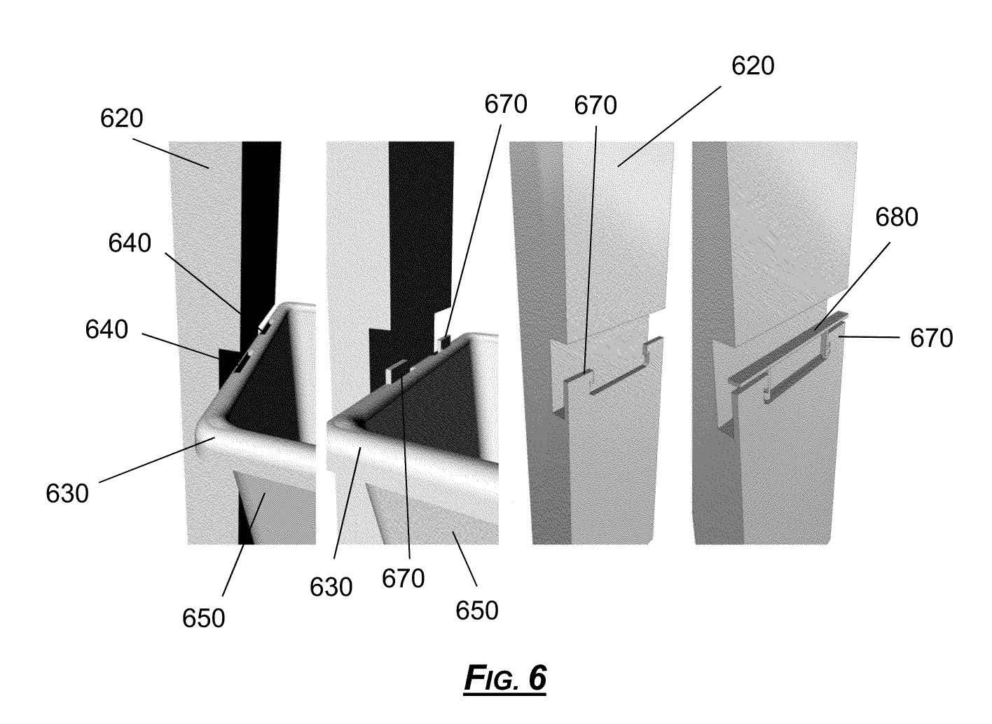

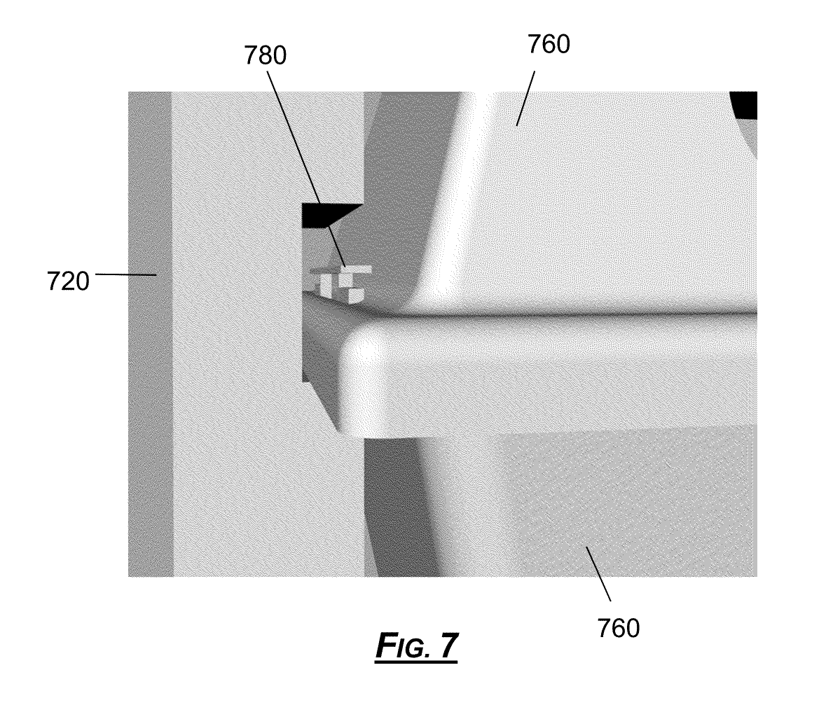

As shown in more detail in FIG. 6, a housing component base 650 has an edge 630 that has two apertures 640 configured to receive flanges 670 of support structure 620. A locking mechanism 680 can extend across the flanges 670 once the housing component base 650 has been installed (although shown here with the locking mechanism 680 installed without the housing component base 650), and the locking mechanism 680 can extend downwards to engage and interlock with a lower recess of the flanges 670. FIG. 7 shows a locking mechanism 780 engaged when a housing component base 750 and housing component cover 760 are installed on a support structure 720.

In an alternative embodiment, the support structure 120, 125 can include detachable J-shaped hooks, or a plate, that can engage an aperture in the housing component. In another alternative embodiment, rather than using the support structure shown in the exemplary embodiment, the J-shaped hooks or mechanism for securing the housing components can be secured to a fence line, carport post, porch post, pergola, cabana, trellis, or the like.

Referring to FIG. 5B, a fence line configuration is shown. A fence line 510 has a plurality of boards, which can be configured as a picket, lattice, concave, convex, board on board, shadowbox, privacy, or other type of fence. A housing component base 550 and a housing component cover 560 can be secured to each other to form a housing component, and the housing component can be secured to the fence line 510. A plurality of J-shaped lips 570 can be secured to the fence line using screws, nails, adhesive, or the like. The J-shaped lips 570 are shown as being J-shaped, though any configuration can be used. By sliding the housing component downwardly, the lips 570 can engage a corresponding component on the housing component base 550 or cover 560 to secure the housing component in place. In this exemplary embodiment, a J-shaped lip is shown for securing each side of the housing component, though one more may be used.

When the system is packaged as a kit, the kit may include components for assembly including a container, housing components, a pipe, and a pump. Optionally, a support structure may be included. Alternatively, a separate support structure can be constructed from plastic, wood, wood composite, metal, or other rigid material. In such a configuration, the support structure may include a hook, plate, or flange secured to the support structure that can interface with the housing components.

The container 110 has a cover 180 that is substantially flat. The cover 180 may comprise one or more components configured to assemble together on the top of the container 110 and attach to an upper edge of the sides of the container 110 (e.g., using an L-shaped or J-shaped lip on the cover 180 engaging an L-shaped or J-shaped flange on the container 110).

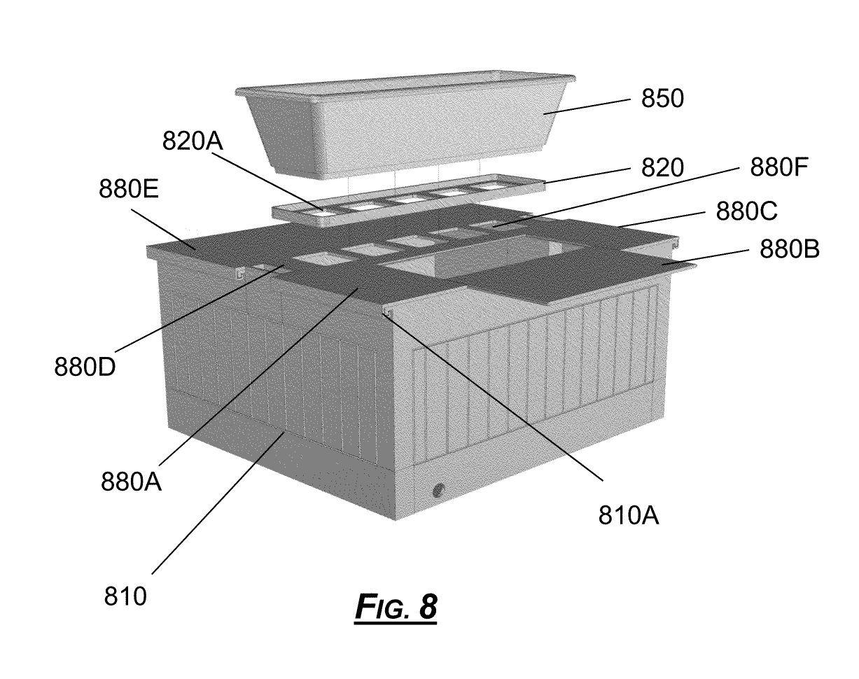

Referring to FIG. 8, a container 810 is shown with a plurality of cover components 880A, 880B, 880C, 880D, 880E. In this embodiment, the cover components are configured to slide onto the top of the container 810. The cover components 880A, 880C, 880D, 880E have an L-shaped or J-shaped lip that can interlock with a flange 810A on an upper edge of a side of the container 810, and the interlocking relationship can prevent movement of the cover components 880A, 880B, 880C, 880D, 880E on the container 810 as well as the structure pieces. A central cover component 880D can have a plurality of apertures 880F that can be substantially aligned with apertures 820A in an optional spacer 820, which is substantially aligned with a plurality of apertures in a housing component 850. Cover component 880B can be configured to slide to allow access to the cavity within container 810.

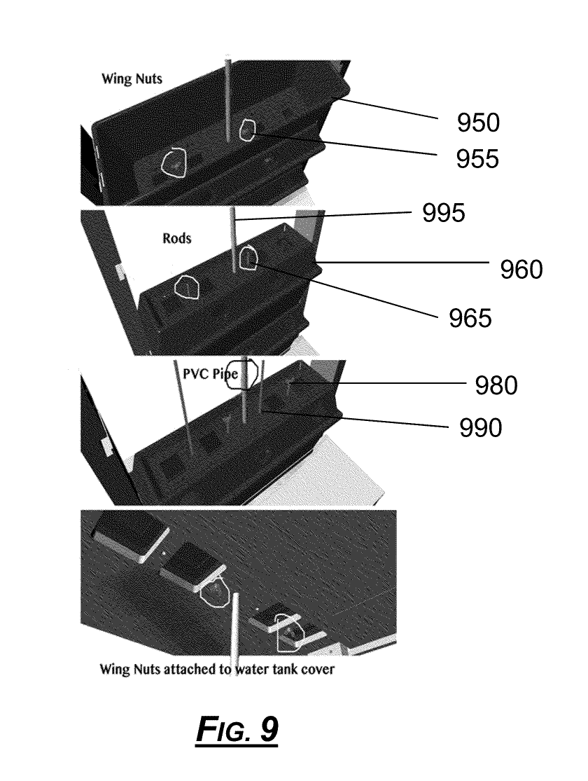

As housing component bases 150 and covers 160 are stacked on the system 100, the housing component bases 150 and covers 160 can be further secured to each other and the container 110. As shown in FIG. 9, rods 990 and a pipe 995 (e.g., PVC pipe) can extend through apertures 965 in a housing component cover 960 and through apertures 955 in a housing component 950. The rod 990 can be secured using couplers and wing nuts 980.

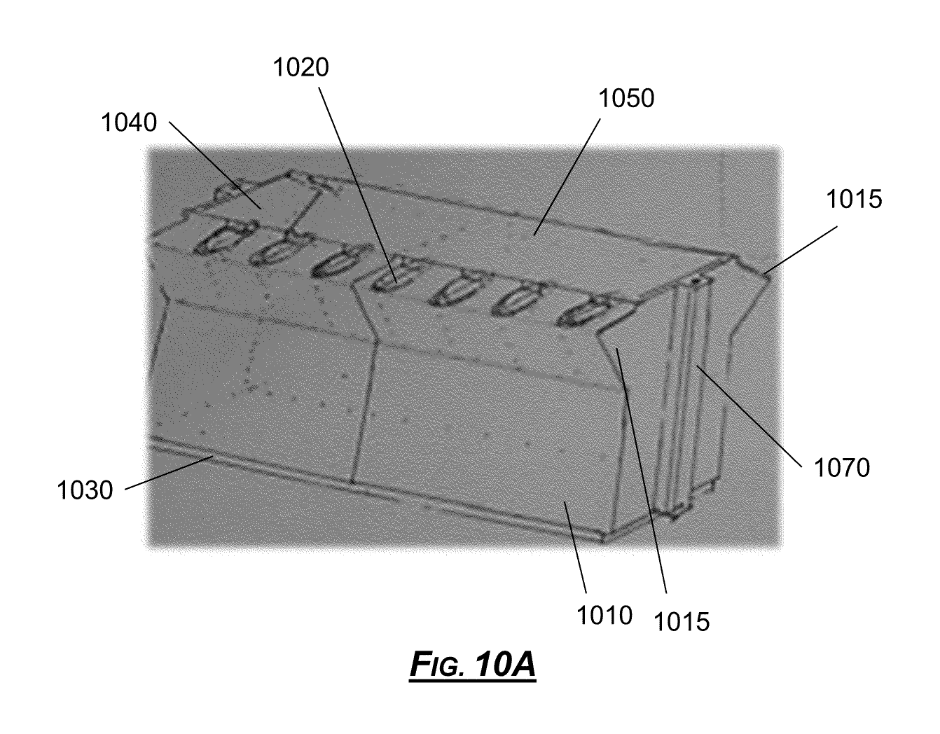

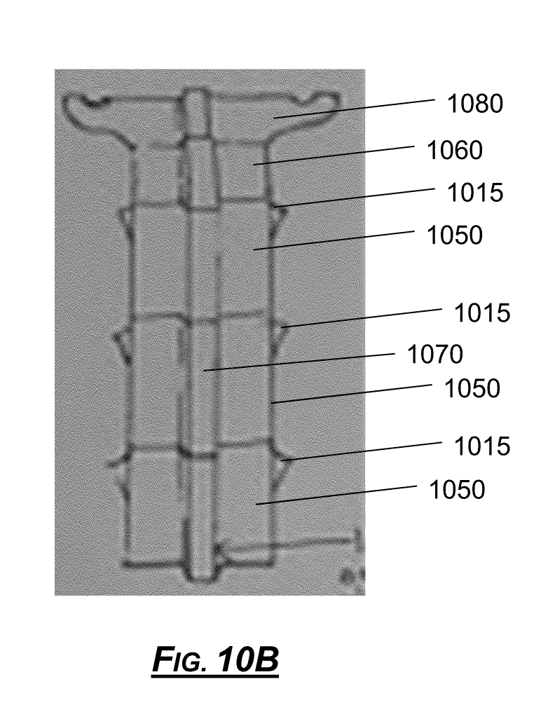

As shown in FIG. 10A, an alternative housing component configuration is shown, whereby the housing component can be formed from a single component. The housing component 1050 has a bottom surface and four sides. Side 1010 and the opposing side (not shown) have a protruding portion 1015 that extends outwardly from the vertical plane extending from the bottom surface to the top surface. In an upper side of the protruding portion 1015, a plurality of apertures 1020 are spaced along the length of the housing component 1050. The housing component 1050 is also configured to be stacked upon another housing component 1050 and supported by a support structure, whereby the protruding portion 1015 and the apertures 1020 thereon remain exposed when the housing components 1050 are stacked.

A lower edge of the housing component 1050 can include a tapered or recessed edge 1030. An upper surface 1040 can be recessed to receive a tapered edge 1030 of another housing component 1050 when the other housing component 1050 is stacked on top. The upper surface 1040 can be configured such that it can hold the housing component securely in place when the tapered edge 1030 is placed therein.

The housing component 1050 can include a tail 1070. A support structure can be routed to include a socket that is configured to receive the tail 1070 to form a dovetail joint. The tail 1070 can slide into the socket of the support structure. In such a configuration, a hook, bracket, or plate is not needed.

The housing component cover 160 has apertures 170 and the housing component 1050 has apertures 1020. These apertures 170, 1020 can be configured to receive a net cup. The aperture 170, 1020 may include a ledge for supporting the net cup positioned therein. The net cup can be configured to include a plurality of vents, cutouts, apertures, holes, or the like, to allow roots to pass through and for excess water to drain. The net cup can be a cylindrical container, or it may take any other shape such that a cavity is formed within the cup housing and the net cup can be secured to the housing component 160, housing component 1050. In the exemplary embodiment, the net cup can rest in the aperture. In another example, the net cup can slide into an aperture or can include flanges such that the net cup can be squeezed to allow the net cup to be inserted and then the flanges engage an inner side when the cup is released. The net cups can be releasably attached to allow net cups to be replaced or removed.

Referring to FIG. 10B, a stacked configuration of housing components is shown. Each housing component 1050 can be vertically stacked upon another housing component 1050. As shown in this side view, when the housing components 1050 are stacked, the protruding portion 1015 extends from the vertical plane. The housing components 1050 may be secured to a support structure using a tail 1070. Above the uppermost housing component 1050 is an adapter component 1060, which allows the housing component to couple to a beam 1080. Beam 1080 may be used for ornamental purposes or may be used to secure a trellis or latticework to the structure.

Although a net cup is shown in the exemplary embodiment, it is intended that other configurations of cups can be used that are within the spirit of this disclosure. For example, the net cup can be a cup without vents or holes. The net cup can hold the plant and growing media in the aperture or in another component, such as an elbow or attachable cup.

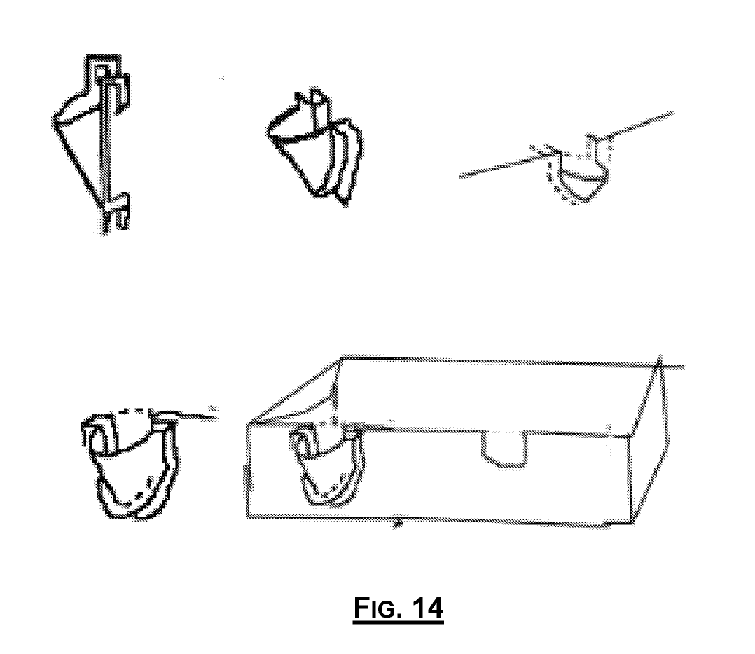

In one configuration of the alternative housing component shown in FIG. 10A, the housing component may not include the protruding portion. Instead, the housing component may have a vertical wall with at least one aperture, where the aperture can receive an attachable/detachable cup or elbow or a cup that is integrated into the housing component. Exemplary cup configurations are shown in FIG. 14. An elbow unit can be curved, whereby a lathed or smaller end can fit in an aperture, and the opposing end can extend from the housing component. The elbow unit may have an opening at each end without any vents or holes in its sidewall.

Within the net cup, the plants can grow in a sterile growing media, such as rock wool, which can be inserted into the net cup before planting. Other exemplary growing media include grow stones, coir peat, rice husks, perlite, vermiculite, pumice, sand, gravel, wood fibre, sheep wool, brick shards, and polystyrene packing peanuts. When the water passes through each housing component, the water trickles over the rock wool and plant roots.

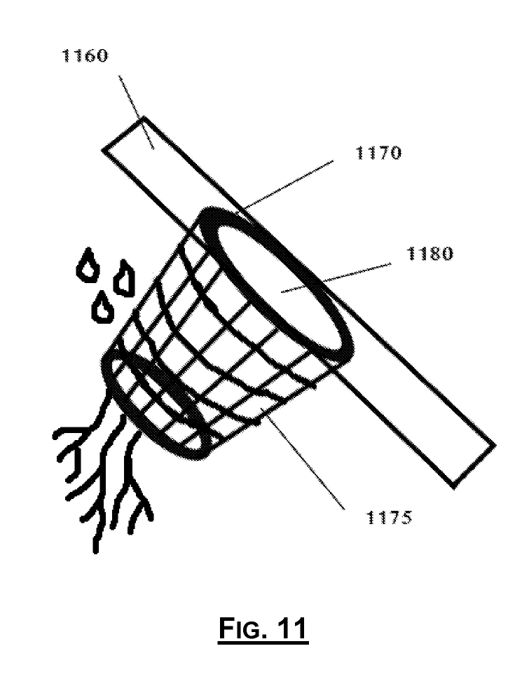

Referring to FIG. 11, a housing component 1160 with an installed cup 1170 is shown. The cup 1170 rests in an aperture, and may be positioned at an angle. The cup 1170 has a plurality of vents 1175 that allow roots of a planting 1180 to extend there through.

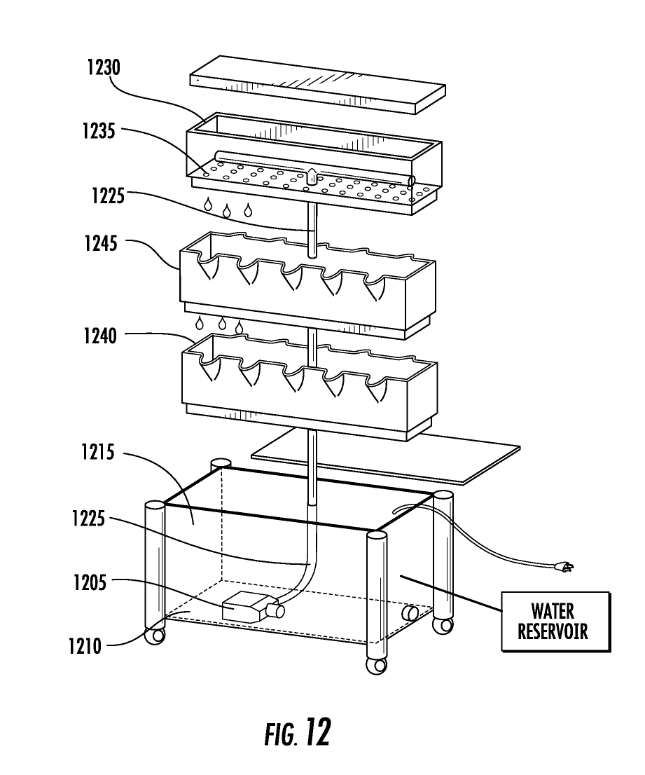

As shown in FIG. 12, in operation, a pump 1205 in the water 1210 inside of a container 1215 is coupled to a timer 1220. The pump 1205 can move nutrient-enriched water from the water reservoir 1210 through a pipe 1225 (e.g., PVC pipe) through each housing component to the top of the system, where a top component 1230 with drip holes 1235 allows the water to drop on the roots of the plants within housing components 1240, 1245. The water passes through each level of housing components until it returns to the water reservoir 1210 where it can be recycled. In an embodiment without the top component (e.g., as shown in FIG. 1), the water can drip from a top housing component cover through holes to a housing component below until it reaches the container where the water can be recycled.

A trellis can be added and secured to the system. For example, the trellis can be secured to the cross beam or a top of the support structure. The trellis can be used for plants that wrap around the trellis components. The cross beam can include a recess to receive trelliswork or for hooking a trellis netting.

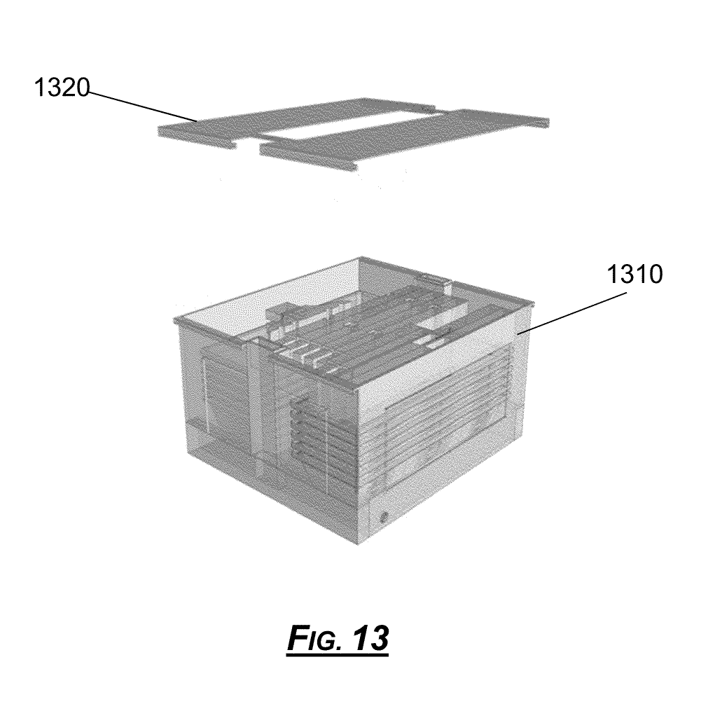

The system can be packaged within the container for travel or sale. As shown in FIG. 13, components of a disassembled system can be placed within a container 1310 and a lid 1320 can be secured to the container 1310. The system can be configured as a kit or as a pre-fabricated system. Because the housing component bases 150 and covers 160 can be configured with a sloped edge, they can be easily stacked within each other to more compactly fit within the container 110 for storage.

While a number of exemplary aspects and embodiments have been discussed above, persons of skill in the art will recognize certain modifications, permutations, additions and sub-combinations thereof. It is therefore intended that the following appended claims, as well as additional claims that may be hereafter introduced, are interpreted to include all such modifications, permutations, additions and sub-combinations as are within their true spirit and scope.

The words “comprise,” “comprises,” “comprising,” “composed,” “composes,” “composing,” “include,” “including,” and “includes” when used in this specification, including the claims, are intended to specify the presence of stated features, integers, components, or steps, but they do not preclude the presence or addition of one or more other features, integers, components, steps, or groups thereof. Moreover, the invention as disclosed herein may be suitably practiced in the absence of specific elements which are disclosed herein.

What is claimed is:

1. A hydroponic garden system comprising:
a container configured to hold water;
a support structure extending upward from the container, wherein the container is configured to receive a portion of the support structure in at least one recess of the container;
a plurality of housing components, each housing component configured to be supported by the support structure and positioned vertically along the support structure, each housing component having a plurality of apertures, wherein each aperture is configured to support a vessel configured for holding a plant;
a container cover configured to secure the support structure and housing components in a fixed position;
a pipe extending upward from the container through the housing components; and
a pump configured to pump water from the container through the pipe to an upper most housing component, whereby water drips from the upper most housing component to the housing component below.

2. The hydroponic garden system of claim 1, whereby when the at least one recess in the container receives the portion of the support structure and the container is substantially filled with water, the container weighs on and secures the portion of the support structure.

3. The hydroponic garden system of claim 1, wherein each housing component comprises a housing component base and a housing component cover, and wherein the housing component cover comprises the plurality of apertures.

4. The hydroponic garden system of claim 3, wherein the housing component cover has a first amount of apertures on a first side, and the housing component cover has a second amount of apertures on a second side opposing the first side.

5. The hydroponic garden system of claim 1, wherein the support structure comprises a first support structure component on a first side of the container and a second support structure component on a second side of the container opposing the first side.

6. The hydroponic garden system of claim 5, further comprising a cross beam configured to couple the first support structure component and the second support structure component at the top of the support structure.

7. The hydroponic garden system of claim 1, wherein the housing component extends outwardly at an edge, and the support structure interfaces with the edge to support the housing component.

8. The hydroponic garden system of claim 1, wherein the support structure comprises a hook, a plate, or a flange to interface with the edge of the housing component.

9. The hydroponic garden system of claim 1, further comprising a rod that extends through at least two housing components.

10. The hydroponic garden system of claim 1, wherein the housing component comprises a plurality of apertures in a bottom surface and a plurality of apertures in a top surface, wherein stacking a first housing component on a second housing component substantially aligns the apertures.

11. The hydroponic garden system of claim 1, wherein the container is configured to house the support structure, the housing components, the pipe, and the pump.

12. The hydroponic garden system of claim 1, wherein the housing component comprises a first side and an opposing second side, wherein the first side and the second side are substantially parallel to the vertical plane of the system, wherein the first side and second side each comprise a protruding portion, wherein the protruding portion comprises the plurality of apertures on an upper side of the protruding portion.

13. The hydroponic garden system of claim 12, wherein the housing component is configured such that stacking a first housing component on a second housing component allows the upper side of the protruding portion to remain exposed.

14. A kit for a hydroponic garden comprising:
a container configured to hold water, the container comprising at least one recess configured to receive a portion of a support structure, whereby the support structure is configured to extend upwardly from the container;
a plurality of housing components, each housing component configured to be supported by the support structure, each housing component having a plurality of apertures, wherein each aperture is configured to support a vessel configured for holding a plant;
a container cover configured to secure the support structure and housing components in a fixed position;
a pipe configured to be installed to extending upward from the container through the housing components; and
a pump configured to pump water from the container through the pipe.

15. The hydroponic garden system of claim 14, whereby when the at least one recess in the container receives the portion of the support structure and the container is substantially filled with water, the container weighs on and secures the port of the support structure.

16. The kit of claim 14, wherein each housing component comprises a housing component base and a housing component cover, and wherein the housing component cover comprises the plurality of apertures.

17. The kit of claim 16, wherein the housing component cover has a first amount of apertures on a first side, and the housing component cover has a second amount of apertures on a second side opposing the first side.

18. The kit of claim 14, wherein the support structure comprises a first support structure component configured to interface with a first side of the container and a second support structure component configured to interface with a second side of the container opposing the first side.

19. The kit of claim 18, further comprising a cross beam configured to couple the first support structure component and the second support structure component.

20. The kit of claim 14, further comprising a rod that is configured to be installed to extend through at least two housing components.

21. The kit of claim 14, wherein the housing component comprises a plurality of apertures in a bottom surface and a plurality of apertures in a top surface, wherein stacking a first housing component on a second housing component substantially aligns the apertures.

22. The kit of claim 14, wherein the container is configured to house the support structure, the housing components, the pipe, and the pump.

23. The kit of claim 14, wherein the housing component comprises a first side and an opposing second side, wherein the first side and the second side are substantially parallel to the vertical plane of the system, wherein the first side and second side each comprise an protruding portion, wherein the protruding portion comprises the plurality of apertures on an upper side of the protruding portion.
